(19) United States
(12) Patent Application Publication
(10) Pub. No.: US 2026/0357881 A1
(43) Pub. Date: Nov. 12, 2026

(54) Transmission Device for a Motor Vehicle, and Motor Vehicle, in Particular Motor Car

(71) Applicant: Mercedes-Benz Group AG, Stuttgart (DE)

(72) Inventors: Carsten GITT, Stuttgart (DE); Tobias HAERTER, Stuttgart (DE); Jochen STOESSER, Esslingen (DE); Andreas KOLB, Wernau (DE)

(21) Appl. No.: 19/121,994

(22) PCT Filed: Oct. 26, 2023
(86) PCT No.: PCT/EP2023/080012

§ 371 Date: Apr. 17, 2025

(30) Foreign Application Priority Data
Oct. 31, 2022 (DE) 10 2022 004 088.3

(51) Int. Cl. F16H 48/11; F16H 48/10

(52) U.S. Cl. CPC F16H 48/11; F16H 2048/106

(57) ABSTRACT

A transmission device includes a spur gear differential with a first sun gear as a first driven gear of the spur gear differential and as a first spur gear and has a first rolling circle diameter. The spur gear differential has a second sun gear arranged coaxially to the first sun gear as a second driven gear and as a second spur gear and has a second rolling circle diameter. The spur gear differential has a planetary gear set via which the sun gears are coupled to each other such that the sun gears rotate in opposite directions. The planetary gear set has a planetary carrier and a first differential planetary gear which engages into the first sun gear, has a third rolling circle diameter and is held on the planetary carrier and is rotatable around a first planetary rotational axis relative to the planetary carrier.

### BACKGROUND AND SUMMARY OF THE INVENTION

The invention relates to a transmission device for a motor vehicle. Furthermore, the invention relates to a motor vehicle, in particular a motor car, having such a transmission device.

A spur gear differential transmission is taken as known from DE 10 2014 203 522 A1. Furthermore, DE 10 2015 214 035 B4 discloses an electronic drive unit for a motor vehicle. A transmission device for a motor vehicle is also known from DE 10 2018 128 836 B3.

The object of the present invention is to create a transmission device for a motor vehicle and a motor vehicle having such a transmission device, so that a particularly compact and weight-optimized construction and a particularly high torque density of the transmission device can be realized.

A first aspect of the invention relates to a transmission device for a motor vehicle, also simply referred to as a vehicle, which is preferably designed as a motor car, in particular as a passenger car. This means that, in its completely produced state, the motor vehicle has the transmission device and can be driven via the transmission device, in particular by means of a drive motor of the motor vehicle. In particular, vehicle wheels, also simply referred to as wheels, of the motor vehicle, in particular of the same vehicle axle, also simply referred to as an axle, of the motor vehicle, can be driven via the transmission device, in order to drive the motor vehicle as a whole.

The transmission device has a spur gear differential which is also referred to as a spur gear differential transmission. The spur gear differential is thus a differential transmission, also simply referred to as a differential, which is designed as a spur gear differential. For example, the mentioned vehicle wheels can be driven via the spur gear differential, in particular by a drive shaft of the motor vehicle. In this case, for example, the spur gear differential has the function, well known from the prior art, of distributing and transmitting a drive torque, that can be or is provided by the drive shaft, to the vehicle wheels, in particular to side shafts, by which the vehicle wheels can be driven. For example, the spur gear differential also has the function of enabling different rotational speeds of the vehicle wheels and thus of the side shafts when the motor vehicle is cornering, in such a way that the outside vehicle wheel can rotate or rotates with a higher rotational speed than the inside vehicle wheel, in particular when the vehicle wheels can be or are driven via the spur gear differential by the drive shaft. The mentioned side shafts can be a component of the spur gear differential, for example. For example, a first of the vehicle wheels can be driven by a first of the side shafts, and a second of the vehicle wheels can be driven by a second of the side shafts. In particular, the side shafts can be arranged coaxially to each other. In particular, the vehicle wheels are arranged on sides of the vehicle that are opposite each other in the vehicle transverse direction of the motor vehicle, also simply referred to as a vehicle.

The spur gear differential has a first sun gear which is designed as a first driven gear of the spur gear differential and as a first spur gear. The first sun gear has a first rolling circle diameter. In particular, the first sun gear has a first pitch circle diameter. For example, the first sun gear is connected, in particular permanently, to the first side shaft for conjoint rotation, so that, for example, the first side shaft can be driven by the first sun gear and so that, for example, the first vehicle wheel can be driven via the first side shaft by the first sun gear. The spur gear differential furthermore has a second sun gear which is designed as a second driven gear of the spur gear differential and as a second spur gear. For example, the second sun gear is, in particular permanently, connected to the second side shaft for conjoint rotation, so that the second side shaft can be driven by the second sun gear. Thus, the second vehicle wheel can be driven by the second sun gear via the second side shaft. The sun gears are arranged coaxially to each other. In other words, for example, the second sun gear is arranged equixially to a circumferential axis of the first sun gear. Again, expressed in other words: The first sun gear can be rotated around a first sun gear rotational axis, in particular relative to a housing of the transmission device. In this case, the first sun gear is arranged at least partially in the housing, for example. The second sun gear can be rotated, for example, around a second sun gear rotational axis relative to the housing, in which, for example, the second sun gear is at least partially arranged, and because the sun gears are arranged coaxially to each other, the sun gear rotational axes coincide. In particular, for example, the first side shaft is arranged coaxially to the first sun gear and, for example, the second side shaft is arranged coaxially to the second sun gear.

In the scope of the present disclosure, the feature that two components are connected to each other for conjoint rotation is understood to mean that the two components are designed integrally with each other, i.e., formed from a single piece and therefore are connected to each other for conjoint rotation, so that the two components are designed integrally with each other as a monoblock, i.e., are formed by a monoblock. Again, expressed in other words, the components designed integrally with each other are formed by a single and thus integrally produced, integral body. It is also conceivable that the two components connected to each other for conjoint rotation are designed separately from each other and in particular are connected to each other for conjoint rotation, in particular by a joining technique. The components connected to each other for conjoint rotation can be or are rotated around a component rotational axis, common to the components, in particular relative to the housing, in particular when the components are driven so that the components can be or are rotated around the component rotational axis together or simultaneously at the same angular velocity, in particular relative to the housing. Furthermore, relative rotations between the components around the component rotational axis are prevented.

The second sun gear, designed as a spur gear, has a second rolling circle diameter which is different from the first rolling circle diameter. Thus, for example, the first rolling circle diameter is larger than the second rolling circle diameter or vice versa. In particular, the second sun gear has a second pitch circle diameter which is different from the first pitch circle diameter so that, for example, the first pitch circle diameter is larger than the second pitch circle diameter or vice versa.

The transmission device also has a planetary gear set which is also referred to as a planetary arrangement or orbiting planetary arrangement. The sun gears can be coupled to each other by means of the planetary gear set or via the planetary gear set, in such a way that the sun gears can be rotated in opposite directions. This can be understood to mean the following in particular: The mentioned vehicle wheels are ground contact elements of the motor vehicle, also referred to as a vehicle, which can be or is supported downwards in the vehicle vertical direction of the motor vehicle on the ground, such as a road, for example, via the ground contact elements. If the vehicle wheels and thus the motor vehicle are driven so that the motor vehicle is driven along the ground while the motor vehicle is supported downwards in the vehicle vertical direction on the ground via the ground contact elements (vehicle wheels), the vehicle wheels roll, in particular directly on the ground. If, for example, the motor vehicle is now raised at least partially in such a way that the vehicle wheels do not touch the ground and float in the air, so to speak, and if, for example, the first vehicle wheel and thus the first side shaft and the first sun gear are then rotated around the first sun gear rotational axis in a first direction of rotation, then, as is well known from conventional differential transmissions, the second sun gear and the second side shaft are thereby driven via the planetary gear set, and the second vehicle wheel is driven via the second side shaft, in such a way that the second sun gear and thus, for example, the second side shaft are rotated around the second sun gear rotational axis and thus around the first sun gear rotational axis in a second direction of rotation opposite to the first direction of rotation, i.e., in the opposite direction to the first sun gear.

The planetary gear set has a planetary carrier which is preferably arranged coaxially to the sun gears. The planetary carrier can be rotated around a planetary carrier rotational axis relative to the housing, for example, wherein the planetary carrier can be arranged at least partially in the housing. In particular, it is conceivable that the planetary carrier rotational axis coincides with the sun gear rotational axes, so that preferably the planetary carrier is arranged coaxially to the sun gears. The planetary gear set furthermore has at least one first differential planetary gear which engages into the first sun gear, i.e., meshes with the first sun gear or is engaged with the first sun gear. The first differential planetary gear has a third rolling circle diameter. In particular, the first differential planetary gear has a third pitch circle diameter. For example, the planetary gear set has at least one further or several further first differential planetary gears, wherein the preceding and following embodiments for the at least one first differential planetary gear can be easily transferred to the respective, further first differential planetary gear and vice versa. When the first differential planetary gear is referred to above and in the following, unless otherwise stated, this means the at least one first differential planetary gear. The first differential planetary gear is held on the planetary carrier so as to be rotatable around a first planetary rotational axis relative to the planetary carrier. Preferably, the first planetary rotational axis runs parallel to the respective sun gear rotational axis and/or parallel to the planetary carrier rotational axis, wherein preferably the first planetary rotational axis is spaced apart from the respective sun gear rotational axis and/or from the planetary carrier rotational axis.

The planetary gear set furthermore has at least one second differential planetary gear. It is conceivable that the planetary gear set has at least one further second or several further second differential planetary gears, wherein the preceding and following embodiments for the at least one second differential planetary gear can be easily transferred to the respective, further second differential planetary gear and vice versa. When the second differential planetary gear is referred to above and in the following, unless otherwise stated, this means the at least one second differential planetary gear. The second differential planetary gear engages into the second sun gear. This means it is provided that the second differential planetary gear meshes with the second sun gear or is engaged with the second sun gear. The second differential planetary gear is held on the planetary carrier so as to be rotatable relative to the planetary carrier around a second planetary rotational axis running parallel to the first planetary rotational axis and spaced apart from the first planetary rotational axis. For example, the second planetary rotational axis runs parallel to the respective sun gear rotational axis and/or parallel to the planetary carrier rotational axis, wherein it is preferably provided that the second planetary rotational axis is spaced apart from the respective sun gear rotational axis and/or from the planetary carrier rotational axis.

The planetary gear set furthermore has at least one coupling planetary gear, which is arranged coaxially to the first differential planetary gear, connected to the first differential planetary gear for conjoint rotation and engages into the second differential planetary gear, i.e., is engaged with the second differential planetary gear or meshes with the second differential planetary gear and thereby couples the differential planetary gears to each other, the coupling planetary gear having a fourth rolling circle diameter, differing from the third rolling circle diameter. In particular, the coupling planetary gear has a fourth pitch circle diameter, different from the third pitch circle diameter. The first differential planetary gear and the second differential planetary gear form, for example, a differential planetary gear group, wherein it is conceivable that the spur gear differential has at least one further or several further differential planetary gear groups, wherein the preceding and the following embodiments for the first differential planetary gear group can also be easily transferred to the respective, further differential planetary gear group and vice versa.

The coupling planetary gear and the first differential planetary gear form a differential staged planetary gear which is held on the planetary carrier so as to be rotatable around the first planetary rotational axis relative to the planetary carrier. The differential planetary gears and the coupling planetary gear are further spur gears of the spur gear differential. The first differential staged planetary gear has the first differential planetary gear as a first staged planet and the coupling planetary gear as a second staged planet. In other words, the first differential planetary gear is also referred to as a first staged planet and the coupling planetary gear is also referred to as a second staged planet. It is conceivable that the spur gear differential has at least one further or several further differential staged planetary gears, wherein the preceding and following embodiments for the first differential staged planetary gear can be easily transferred to the respective, further differential staged planetary gear and vice versa.

The differential staged planetary gear and the second differential planetary gear are arranged on different axes. This means in particular that the first planetary rotational axis and the second planetary rotational axis run parallel to each other and are spaced apart from each other, in particular in the radial direction of the planetary gear set and/or in the circumferential direction of the planetary gear set, running around the axial direction of the planetary gear set.

In order to be able to realize a particularly compact, i.e., space-efficient and particularly weight-optimized construction and a particularly high torque density of the transmission device, it is particularly provided according to the invention that a first ratio between the first rolling circle diameter and the second rolling circle diameter and a second ratio between the third rolling circle diameter and the fourth rolling circle diameter are identical. For example, the first ratio is a first quotient which has the first rolling circle diameter in its first numerator and the second rolling circle diameter in its first denominator. More preferably, it is provided that the second ratio is a second quotient which has the third rolling circle diameter in its second numerator and the fourth rolling circle diameter in its second denominator. Thus, it is provided according to the invention that the quotients are identical. The preceding and following embodiments for the rolling circle diameters can also be transferred to the pitch circle diameters and vice versa.

When the sun gears are referred to above and in the following, unless otherwise stated, this means the first sun gear and the second sun gear. In summary, the first sun gear and the second sun gear are referred to as driven gears or driven sun gears, wherein the first sun gear is a first of the driven sun gears and the second sun gear is a second of the driven sun gears.

The invention enables the aforementioned drive torque to be distributed in equal parts, i.e., in half, to the driven sun gears and thus transmitted, i.e., to be able to realize a so-called 50:50 torque distribution. For this purpose, the driven sun gears are designed slightly differently with regard to their rolling circle diameter, i.e., differently sized. However, unfavourable extreme profile shifts and disadvantageous effects resulting therefrom on load-bearing behaviour of toothings of the spur gear differential can be avoided. Consequently, the transmission device can be designed in a particularly weight-optimized and space-efficient manner, and a high torque density can be realized.

In order to be able to realize a particularly compact design, in one embodiment of the invention, it is provided that the first differential planetary gear has a first toothing having a first tooth count and a first toothing module, wherein the first toothing engages into the first sun gear. The first toothing has first teeth having a respective, first tooth height, wherein preferably the first tooth heights are identical. The coupling planetary gear has a second toothing having a second tooth count and a second toothing module, wherein the second toothing engages into the second differential planetary gear. The second toothing has second teeth having a respective, second tooth height, wherein preferably the second tooth heights are identical.

Preferably, it is provided that the first differential planetary gear engages into the first sun gear, but preferably the first differential planetary gear does not engage into the coupling planetary gear, nor into the second sun gear nor into the second differential planetary gear. Furthermore, it is preferably provided that the coupling planetary gear engages into the second differential planetary gear, but preferably the coupling planetary gear does not engage into the first differential planetary gear and does not engage into the first sun gear, and preferably the coupling planetary gear does not engage into the second sun gear. Furthermore, it is preferably provided that the second differential planetary gear engages into the second sun gear and into the coupling planetary gear, wherein preferably the second differential planetary gear does not engage into the first sun gear and does not engage into the first differential planetary gear.

A further embodiment of the invention is characterized in that the first tooth count and the second tooth count are identical, wherein the first toothing module and the second toothing module differ from each other, and wherein the respective first tooth height and the respective second tooth height differ from each other. Therefore, the installation space requirement can be kept particularly low.

In order to be able to realize a particularly compact construction, it is provided in a further embodiment of the invention that the first toothing and the second toothing are oriented rotationally to each other, in particular as viewed around the first planetary rotational axis, in such a way that a respective gap, also referred to as a tooth gap, of the first toothing aligns with a respective gap, also referred to as a tooth gap, of the second toothing of the coupling planet. In other words, it is preferably provided that the or all tooth gaps of the first toothing align with the or all tooth gaps of the second toothing, in particular as viewed in the axial direction of the differential staged planetary gear and thus along the first planetary rotational axis.

In a further particularly advantageous embodiment of the invention, it is provided that the first staged planet and the second staged planet are designed integrally with each other, i.e., are formed from a single piece. In other words, it is preferably provided that the first staged planet and the second staged planet are not designed as components that are designed separately from each other and connected to each other, but preferably the first staged planet and the second staged planet are designed integrally with each other, so that the first staged planet and the second staged planet are designed as a monoblock or are formed by a monoblock. In other words, it is preferably provided that the first staged planet and the second staged planet are formed by a one-piece and thus integrally produced body, which is formed from a single piece. Therefore, the installation space requirement, the weight and the costs can be kept particularly low.

A further embodiment of the invention is characterized in that a transition region is provided, designed or arranged between the first staged planet, which has a first width running in the axial direction of the first staged planet, and the second staged planet, which has a second width, also referred to as a coupling width, running in the axial direction of the second staged planet and thus along the first planetary rotational axis, as viewed in the axial direction of the first staged planet and the second staged planet, wherein the transition region has a third width, also referred to as a transition width. Fundamentally, it is conceivable that the first width and the second width are identical. It is also conceivable that the first width and the second width differ from each other. The first width and the third width can also be the same, or the third width and the first width differ from each other. It is also conceivable that the second width and the third width are identical, or the third width and the second width differ from each other. In particular, it is conceivable that the transition region is free from a toothing, or a toothing, also referred to as a transition toothing, is provided in the transition region, which toothing can be designed, for example, integrally with the first toothing and/or integrally with the second toothing.

For example, a tool outlet of a toothing tool for producing the first toothing of the first differential planetary gear and/or for producing the second toothing of the coupling planetary gear is located in the transition region. Furthermore, it is preferably provided that a radial outer contour of the differential staged planetary gear, in particular a radial outer contour and thus an outer contour, pointing outward in the radial direction of the differential staged planetary gear, of the differential staged planetary gear, does not fall below a first tip circle diameter of the second toothing of the coupling planetary gear in the transition region, but increases or grows, in particular continually, from the first tip circle diameter of the second toothing of the coupling planetary gear to a second tip circle diameter of the first toothing of the first differential planetary gear. Thus, for example, the second tip circle diameter is larger than the first tip circle diameter. The respective aforementioned width runs in the axial direction of the first staged planet and the second staged planet, i.e., in the axial direction of the differential staged planetary gear and thus along the first planetary rotational axis. This means that a particularly compact construction can be ensured, as viewed in particular in the axial direction of the differential staged planetary gear and thus of the transmission device as a whole.

In order to be able to realize a particularly compact construction in the axial direction of the transmission device, it is provided in a further embodiment of the invention that the third width of the transition region is, in particular significantly, smaller than the first width of the first staged planet, in particular of the first toothing, and, in particular significantly, smaller than the second width of the second staged planet, in particular of the second toothing. Preferably, the first width is a first toothing width of the first toothing, and preferably the second width is a second toothing width of the second toothing. The feature that the third width is significantly smaller than the first width and significantly smaller than the second width is understood to mean in particular that, for example, the third width is at most 90 percent, in particular at most 80 percent, most particularly at most 70 percent and most particularly at most 60 percent of the first width and the second width, when the first width and second width are identical, and that the third width, for example, is at most 90 percent, in particular at most 80 percent, most particularly at most 70 percent, and most particularly at most 60 percent of the smaller of the first width and the second width, when the first width and the second width are different. In particular, for example, the third width is less than 50 percent, in particular less than 40 percent, most particularly less than 30 percent, of the first width and the second width or of the smaller of the first width and the second width.

A further embodiment of the invention is characterized in that the first differential planetary gear and the coupling planetary gear are designed separately from each other and are connected to each other, in particular for conjoint rotation, wherein that one of the first and second staged planets, the rolling circle diameter or pitch circle diameter of which is smaller than the rolling circle diameter or pitch circle diameter of the other one of the first and second staged planets, has a projection, designed for example as a peg and also referred to as an extension, on which the other of the first and second staged planets is arranged and fixed. In other words, when the third rolling circle diameter is larger than the fourth rolling circle diameter, the first staged planet is a large planet and the second staged planet is a small planet. When the third rolling circle diameter is smaller than the fourth rolling circle diameter, the first staged planet is a small planet and the second staged planet is a large planet. In this case, it is provided that the small planet has the projection, designed for example as a peg and also referred to as an extension, on which the large planet is arranged and is fixed. For example, the large planet has a hub in which, for example, at least one longitudinal region of the projection of the small planet is arranged, so that the large planet is arranged via its hub on the longitudinal region of the projection of the small planet. In particular, the large planet is fixed on the projection via the hub for conjoint rotation and therefore connected to the small planet for conjoint rotation. Therefore, a particularly space-efficient and cost-effective design can be achieved.

In order to be able to keep the installation space requirement of the transmission device particularly low in particular in the axial direction of the transmission device, it is provided in a further embodiment of the invention that the first staged planet and the second staged planet directly border each other, as viewed in the axial direction of the first staged planet and the second staged planet and thus along the first planetary rotational axis.

In a further embodiment of the invention, the first sun gear has a third toothing having a third tooth count and a third toothing module, wherein the third toothing engages into the first differential planetary gear, in particular into its first toothing. The third toothing has third teeth having a respective, third tooth height, wherein it is preferably provided that the third tooth heights are identical. The second sun gear has a fourth toothing having a fourth tooth count and a fourth toothing module, wherein the fourth toothing engages into the second differential planetary gear, in particular into its fifth toothing. The fourth toothing has fourth teeth having a respective, fourth tooth height, wherein preferably the fourth tooth heights are identical. To realize a particularly space-efficient and weight-optimized construction, it has proven to be particularly advantageous in this case when the third tooth count and the fourth tooth count differ from each other, when the third toothing module and the fourth toothing module are identical, and when the respective third tooth height and the respective fourth tooth height are identical.

In the scope of the present disclosure, ordinal numbers, also referred to as ordinals, such as for example “first”, “second” etc. are not necessarily used in order to specify or imply a number or amount of elements to which the ordinal numbers refer, but to be able to make clear reference to elements or terms which are assigned the ordinal numbers or to which the ordinal numbers refer.

In order to be able to keep the installation space requirement, the costs and the weight particularly low, it is provided in a further embodiment of the invention that all toothings of the spur gear differential have straight-sided splines, i.e., are formed or designed with straight-sided splines.

In order to be able to realize a particularly high torque density in a particularly space-efficient manner, it is provided in a further embodiment of the invention that the transmission device has a planetary transmission, provided in addition to the spur gear differential, which has at least one staged planet gear, which is provided in addition to the differential staged planetary gear and in particular also in addition to the second differential planetary gear and preferably also in addition to the sun gears and in particular is held on the planetary carrier so as to be rotatable around the second planetary rotational axis relative to the planetary carrier, the staged planet gear having a first planetary gear and a second planetary gear. The second planetary gear is also referred to as a third staged planet, and the second planetary gear is also referred to as a fourth staged planet. The third staged planet and the fourth staged planet are preferably spur gears. The third staged planet and the fourth staged planet are connected to each other for conjoint rotation. It is conceivable that the third staged planet and the fourth staged planet are designed integrally with each other, i.e., are formed from a single piece, or the third staged planet and the fourth staged planet are designed separately from each other and are connected to each other for conjoint rotation.

The planetary transmission further has a third sun gear, provided in addition to the first sun gear and in addition to the second sun gear and preferably also in addition to the differential staged planetary gear and in addition to the second differential planetary gear and also preferably in addition to the staged planet gear, the third sun gear being a drive sun gear or referred to as a drive sun gear. The third sun gear is preferably a spur gear. One of the planetary gears of the staged planet gear of the planetary transmission is engaged, i.e., meshes, with the drive sun gear. Preferably, it is provided that the first planetary gear and the second planetary gear, i.e., the third staged planet and the fourth staged planet are different sizes, in particular have different rolling circle diameters from each other and/or different pitch circle diameters from each other, so that, for example, the first planetary gear has a fifth rolling circle diameter and/or a fifth pitch circle diameter and so that, for example, the second planetary gear has a sixth rolling circle diameter and/or a sixth pitch circle diameter. In this case, it is conceivable that the fifth rolling circle diameter and the sixth rolling circle diameter differ from each other. In particular, it is conceivable that the fifth pitch circle diameter and the sixth pitch circle diameter differ from each other. Thus, the fifth rolling circle diameter or the fifth pitch circle diameter is larger than the sixth rolling circle diameter or than the sixth pitch circle diameter. For example, the one planetary gear has the fifth rolling circle diameter or the fifth pitch circle diameter, so that, for example, the other planetary gear of the staged planetary gear of the planetary transmission has the sixth rolling circle diameter or the sixth pitch circle diameter. Thus, preferably one planetary gear is larger than the other planetary gear. In other words, preferably one planetary gear is the larger of the planetary gears so that the other planetary gear is the smaller of the planetary gears. More preferably, the first planetary gear is the one planetary gear, more preferably the other planetary gear is the second planetary gear. Thus, preferably it is provided that the larger planetary gear of the staged planetary gears of the planetary transmission is engaged with the drive sun gear.

The planetary transmission furthermore has a ring gear which is or can be connected to the aforementioned housing for conjoint rotation. In particular, the ring gear can be connected permanently to the housing for conjoint rotation. In particular, the ring gear is arranged at least partially in the housing. The other planetary gear, in particular the smaller planetary gear, is engaged with the ring gear, i.e., engages into the ring gear or meshes with the ring gear. In particular, it is conceivable that the staged planetary gear of the planetary transmission is connected, in particular permanently, to the second differential planetary gear for conjoint rotation, or the staged planetary gear of the planetary transmission can be rotated, in particular the second planetary rotational axis, relative to the second differential planetary gear. More particularly, the staged planetary gear of the planetary transmission is arranged coaxially to the second differential planetary gear. Preferably, the staged planetary gear is thus held on the planetary carrier so as to be rotatable around the second planetary rotational axis relative to the planetary carrier.

In this case, to realize a particularly compact and weight-optimized construction, it has proven to be particularly advantageous when the second differential planetary gear adjoins the ring gear, adjoins the one planetary gear and adjoins the other planetary gear of the planetary transmission, engaging into the ring gear, in a direction running in the axial direction of the second differential planetary gear and thus running in parallel to the second planetary rotational axis or coinciding with the second planetary rotational axis, wherein the ring gear and the other planetary gear of the planetary transmission adjoin the one planetary gear of the planetary transmission, engaging into the drive sun gear, in the same direction, whereby the ring gear and the other planetary gear of the planetary transmission are arranged between the second differential planetary gear of the spur gear differential and the one planetary gear of the planetary transmission, engaging into the drive sun gear, as viewed in the axial direction of the second differential planetary gear and thus along the second planetary rotational axis. Therefore, a particularly compact construction can be achieved in the axial direction of the transmission device.

A further embodiment of the invention is characterized in that the first rolling circle diameter of the first sun gear is larger than the second rolling circle diameter of the second sun gear, which adjoins the first sun gear in an arrangement direction running in the axial direction of the sun gears, wherein the first sun gear adjoins the third sun gear in the same arrangement direction. This means that the first sun gear is arranged between the second sun gear and the third sun gear, as viewed in the axial direction of the sun gears and thus along the respective sun gear rotational axis, whereby the transmission device, a particularly compact construction can be represented in the axial direction.

In order to be able to keep the installation space requirement particularly low, it is provided in a further embodiment of the invention that planetary carrier walls of the planetary carrier, to which planetary carrier walls bolts are fixed, in particular for conjoint rotation, on which the differential staged planetary gear of the spur gear differential, the second differential planetary gear of the spur gear differential and preferably the staged planet gear of the planetary transmission are rotatably held, are located exclusively on the outside, as viewed in the axial direction of the planetary transmission and the spur gear differential and thus along the respective sun gear rotational axis, i.e., adjoin on both sides the ring gear, the second differential planetary gear of the spur gear differential, the differential staged planetary gear of the spur gear differential and the sun gears of the spur gear differential and preferably adjoin the staged planet gear of the planetary transmission, so that the planetary carrier walls opposing each other in the axial direction of the planetary carrier are arranged outside the planetary transmission and outside the spur gear differential, as viewed in the axial direction of the transmission device and thus along the respective sun gear rotational axis.

Furthermore, it has also proven particularly advantageous when the first differential planetary gear is arranged in phase with the staged planetary gear.

In particular, in order to be able to keep the axial installation space requirement particularly low, it is provided in a further embodiment of the invention that the smaller planetary gear of the planetary transmission is arranged between the larger planetary gear of the planetary transmission and the second differential planetary gear of the spur gear differential, as viewed in the axial direction of the second differential planetary gear and thus along the second planetary rotational axis, or preferably the larger planetary gear of the planetary transmission is arranged between the smaller planetary gear of the planetary transmission and the second differential planetary gear of the spur gear differential, as viewed in the axial direction of the second differential planetary gear of the spur gear differential and thus along the second planetary rotational axis.

A second aspect of the invention relates to a motor vehicle, also simply referred to as a vehicle, which preferably is designed as a motor car, in particular as a passenger car. The motor vehicle according to the second aspect of the invention has a transmission device according to the first aspect of the invention. Advantages and advantageous embodiments of the first aspect of the invention are to be regarded as advantages and advantageous embodiments of the second aspect of the invention and vice versa.

Further advantages, features and details of the invention result from the following description of preferred exemplary embodiments and from the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWINGS

FIG. 1 is a schematic front view of a first embodiment of a transmission device for a motor vehicle;

FIG. 2 is a schematic side view of the first embodiment of the transmission device;

FIG. 3 is a schematic side view of a second embodiment of the transmission device;

FIG. 4 is a schematic front view of a first embodiment of a differential staged planetary gear of a spur gear differential of the transmission device;

FIG. 5 shows a second embodiment of the differential staged planetary gear;

FIG. 6 is a schematic front view of a third embodiment of the transmission device;

FIG. 7 is a schematic side view of the third embodiment of the transmission device;

FIG. 8 is a schematic front view of a fourth embodiment of the transmission device;

FIG. 9 is a schematic side view of the fourth embodiment of the transmission device;

FIG. 10 is a detail of a schematic longitudinal sectional view of a third embodiment of the differential staged planetary gear;

FIG. 11 is a detail of a schematic longitudinal sectional view of a fourth embodiment of the differential staged planetary gear; and

FIG. 12 is a detail of a schematic longitudinal sectional view of a fifth embodiment of the differential staged planetary gear.

### DETAILED DESCRIPTION OF THE DRAWINGS

In the figures, identical or functionally identical elements are provided with the same reference signs.

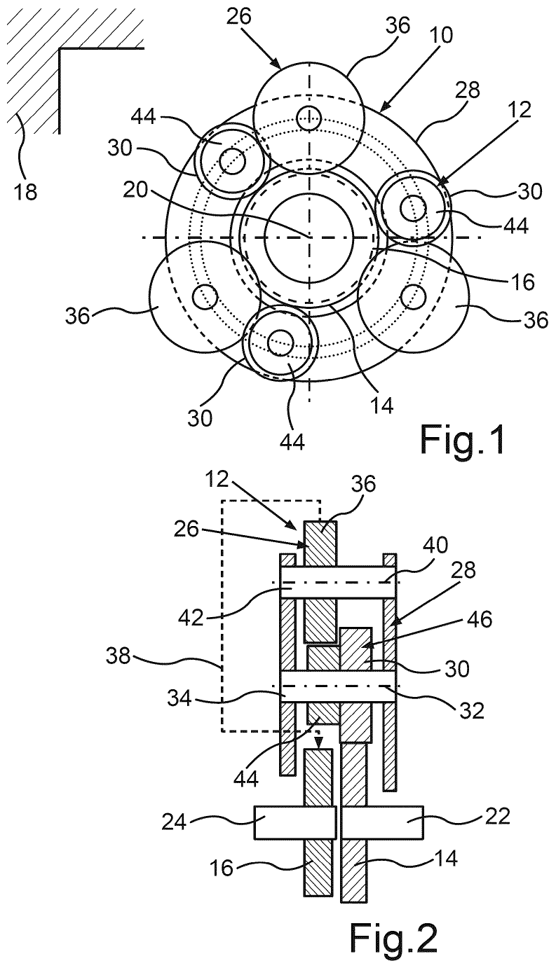

FIGS. 1 and 2 show, in a schematic front view or in a schematic and sectional side view, a first embodiment of a transmission device 10 for a motor vehicle, preferably designed as a motor car, in particular as a passenger car, and also simply referred to as a vehicle. The motor vehicle, in its completely produced state, has for example at least or exactly two vehicle axles, also simply referred to as axles, arranged one behind the other in the vehicle longitudinal direction. The respective vehicle axle has at least or exactly two vehicle wheels which are also simply referred to as wheels. The respective vehicle wheels of the respective vehicle axle are arranged on opposite sides to one another in the vehicle transverse direction of the motor vehicle. The vehicle wheels are ground contact elements, by means of which the motor vehicle is or can be supported downwards on the ground, in the vehicle vertical direction of the motor vehicle. For example, the motor vehicle has at least one drive motor by means of which the vehicle wheels of at least or exactly one of the vehicle axles can be driven via the transmission device 10, whereby the motor vehicle as a whole can be driven. In particular, the drive motor may be an internal combustion engine or also an electric engine, such that, for example, the motor vehicle is designed as a hybrid vehicle or also as an electric vehicle, in particular as a battery electric vehicle (BEV). The vehicle wheels that can be driven via the transmission device 10 are also referred to as drive wheels. When the wheels or vehicle wheels are referred to in the following, unless otherwise stated, this means the drive wheels of the motor vehicle.

The transmission device 10 has a spur gear differential 12, which is also referred to as a spur gear differential transmission. The spur gear differential 12 is a differential transmission, also simply referred to as a differential, which is designed as a spur gear differential transmission. In particular, the spur gear differential 12 is designed as a planetary differential. The spur gear differential 12 has a first sun gear 14, which is also referred to as the first sun. The first sun gear 14 is designed as a first driven gear of the spur gear differential 12. Furthermore, the first sun gear 14 is designed as a first spur gear. In other words, the sun gear 14 is a first gear wheel, which is designed as a spur gear. The first sun gear 14 has a first rolling circle diameter. The spur gear differential 12 also has a second sun gear 16 which is designed as a second driven gear of the spur gear differential 12. The second sun gear 16 is designed as a second spur gear. In other words, the second sun gear 16 is a second gear wheel, which is designed as a spur gear. It can be seen particularly well from FIGS. 1 and 2 that the sun gears 14 and 16 are arranged coaxially to each other. The transmission device 10 has a housing 18, shown particularly schematically in FIG. 1, wherein the spur gear differential 12 is arranged at least partially in the housing 18. The sun gears 14 and 16 can be rotated around a sun gear rotational axis common to the sun gears 14 and 16, relative to the housing 18. The sun gear rotational axis 20 is also simply referred to as a rotational axis, wherein the rotational axis runs in the axial direction of the transmission device 10 and thus of the spur gear differential 12, in particular coincides with the axial direction of the transmission device 10 and thus of the spur gear differential 12. In particular, the axial direction of the transmission device 10 coincides with the axial direction of the spur gear differential 12, whose radial direction coincides with the radial direction of the transmission device 10. The second sun gear 16 is designed as a second driven gear of the spur gear differential 12. The spur gear differential 12 can provide output drive torques via its driven gear, i.e., via the sun gears 4 and 16, by means of which output torques the drive wheels can be driven. In particular, the respective output drive torque, which is or can be provided by the respective sun gear 14, 16, results from a drive torque which can be or is introduced into the spur gear differential 12. For example, the drive torque can be provided by the drive motor or the drive torque results from another torque which can be provided by the drive motor. In particular, the drive torque can be divided, in particular in two, and distributed to the vehicle wheels by means of the spur gear differential 12. It can be seen from FIG. 2 that a first shaft, designed as a first side shaft 22, and a second shaft, designed as a second side shaft 24, can be driven by the first sun gear 14 and by the second sun gear 16, respectively, wherein a first of the drive wheels can be driven by the side shaft 22 and a second of the drive wheels can be driven by the side shaft 24. In particular, in the present case, it is provided that the first sun gear 14 is provided, in particular permanently to the first side shaft 22 for conjoint rotation, and alternatively or additionally, the second sun gear 16 is connected, in particular permanently, to the second side shaft 24 for conjoint rotation. The second sun gear 16 has a second rolling circle diameter, different from the first rolling circle diameter, wherein in the present case the second rolling circle diameter is smaller than the first rolling circle diameter. The second sun gear 16 is also referred to as a second sun, small sun, or smaller sun, and the sun gear 14 is also referred to as a first sun, larger sun or large sun.

The spur gear differential 12 also has a planetary gear set 26, by means of which the sun gears 14 and 16 are coupled to each other in such a way that the sun gears 14 and 26 can be rotated in particular around the rotational axis relative to the housing 18 in opposite directions. The planetary gear set 26 has a planetary carrier 28 which is also referred to as a web and in the present case is arranged coaxially to the sun gears 14 and 16. The planetary carrier 28 can be rotated around the rotational axis (sun gear rotational axis 20) relative to the housing 18. Furthermore, the planetary gear set 26 has a first differential planetary gear 30. In particular, the planetary gear set 26 has at least one further or several further first differential planetary gears, wherein the following and preceding embodiments for the first differential planetary gear 30 can be easily transferred to the respective, further first differential planetary gear and vice versa. The first differential planetary gear 30 engages into the first sun gear 14, i.e., meshes with the first sun gear 14 or is engaged with the first sun gear 14. Furthermore, the first differential planetary gear 30 is held on the planetary carrier 28 so as to be rotatable around a first planetary rotational axis 32 relative to the planetary carrier 28. Furthermore, the first differential planetary gear 30 has a third rolling circle diameter. In the first embodiment, the first differential planetary gear 30 is assigned a first bolt 34 which is also referred to as a first planetary bolt. In particular, the first differential planetary gear 30 is arranged on the bolt 34, in particular mounted thereon, so as to be rotatable around the first planetary rotational axis 32 relative to the bolt 34 and relative to the planetary carrier 28, wherein, for example, the bolt 34 itself is fixed on the planetary carrier 28, in particular for conjoint rotation.

The planetary gear set 26 also has at least one second differential planetary gear 36. In particular, it is conceivable that the planetary gear set 26 has at least one further or several further second differential planetary gears, wherein the preceding and following embodiments for the second differential planetary gear 36 can be easily transferred to the respective, further second differential planetary gear and vice versa. The second differential planetary gear 36 engages into the second sun gear 16, which is represented by a dashed arrow 38 in FIG. 2. In other words, the second differential planetary gear 36 meshes with the sun gear 16 or the second differential planetary gear 36 is engaged with the second sun gear 16. The dashed arrow 38 means “meshes with”. The second differential planetary gear 36 is held on the planetary carrier 28 so as to be rotatable around a second planetary rotational axis 40 relative to the planetary carrier 28. It can be seen from FIG. 2 that the second planetary rotational axis 40 runs parallel to the first planetary rotational axis 32 and is spaced apart from the planetary rotational axis 32. Furthermore, the planetary rotational axes 32 and 40 run parallel to the rotational axis (sun gear rotational axis 20), and the planetary rotational axes 32 and 40 are each spaced apart from the rotational axis. In the first embodiment, the second differential planetary gear 36 is assigned a second bolt 42 which is also referred to as a second planetary bolt. The second differential planetary gear 36 is arranged, in particular mounted, on the second bolt 42 so as to be rotatable around the second planetary rotational axis 40 relative to the bolt 42 and relative to the planetary carrier 28, wherein, for example, the second bolt 42 itself is fixed on the planetary carrier 28, in particular for conjoint rotation.

The planetary gear set 26 also has at least one coupling planetary gear 44. In particular, the planetary gear set 26, in particular each first differential planetary gear, has a respective coupling planetary gear, such as the coupling planetary gear 44. The first differential planetary gear 30, the second differential planetary gear 36 and the coupling planetary gear 44 are designed as spur gears, i.e., gear wheels, which are designed as spur gears. The coupling planetary gear 44 is arranged coaxially to the first differential planetary gear 30 and, in particular permanently, connected to the first differential planetary gear 30 for conjoint rotation. The coupling planetary gear 44 engages into the second differential planetary gear 36, whereby the differential planetary gears 30 and 36 are coupled to each other via the coupling planetary gear 44, in particular in a torque-transmitting manner. The coupling planetary gear 44 has a fourth rolling circle diameter, differing from the third rolling circle diameter of the first differential planetary gear 30. Furthermore, the first differential planetary gear 30 and the coupling planetary gear 44 assigned to it form a differential staged planetary gear 46, which is also referred to as a differential staged planet. Thus, the planetary gear set 26 has the differential staged planetary gear 46. In particular, for example, the planetary gear set 26 has at least one further or several further differential staged planetary gears, wherein the preceding and following embodiments for the differential staged planetary gear 46 can be easily transferred to the respective, further differential staged planetary gear and vice versa. Furthermore, the differential staged planetary gear 46 is held on the planetary carrier 28 so as to be rotatable around the first planetary rotational axis 32 relative to the planetary carrier 28. In the present case, this is realized in that the differential staged planetary gear 46 is arranged, in particular mounted, on the bolt 34 so as to be rotatable around the first planetary rotational axis 32 relative to the bolt 34 and relative to the planetary carrier 28, so that the coupling planetary gear 44 is also arranged, in particular mounted, on the bolt 34 so as to be rotatable around the first planetary rotational axis 32 relative to the bolt 34 and relative to the planetary carrier 28. The first differential planetary gear 30 is a first staged planet of the differential staged planetary gear 46 or is also referred to as a first staged planet of the differential staged planetary gear 46. Consequently, the coupling planetary gear 44 is a second staged planet of the differential staged planetary gear 46 or the coupling planetary gear 44 is also referred to as a second staged planet of the differential staged planetary gear 46. In the first embodiment, the fourth rolling circle diameter of the coupling planetary gear 44 is smaller than the third rolling circle diameter of the first differential staged planetary gear 46 so that the coupling planetary gear 44 is also referred to as a small staged planet or smaller staged planet or small planet, and so that the first differential planetary gear 30 is also referred to as a large staged planet or larger staged planet or larger planet.

In order to be able to realize a particularly compact and weight-optimized construction of the transmission device 10 and a particularly high torque density, it is provided that a first ratio between the first rolling circle diameter and the second rolling circle diameter and a second ratio between the third rolling circle diameter and the fourth rolling circle diameter are identical. In this case, for example, the first differential planetary gear 30 has a first toothing, having a first tooth count and a first toothing module, which first toothing engages into the first sun gear 14 and has first teeth with a respective, first tooth height. The coupling planetary gear 44 has, for example, a second toothing, having a second tooth count and a second toothing module, which second toothing engages into the second differential planetary gear 36 and has second teeth with a respective, second tooth height. In this case, it is preferably also provided that the first tooth count and the second tooth count are identical, and that the first toothing module and the second toothing module differ from each other, so that the respective first relation and the respective second relation differ from each other.

FIG. 4 shows a first embodiment of the differential staged planetary gear 46, in a schematic front view. In FIG. 4, the first toothing of the first differential planetary gear 30 is labelled with 48, the first teeth of which are labelled with 50. The second toothing of the coupling planetary gear 44 is labelled with 52 in FIG. 4, the second teeth of which are labelled with 54. It can be seen that the first toothing 48 also has first gaps 56, which are also referred to as first tooth gaps. In the circumferential direction, running around the planetary rotational axis 32, of the toothing 48 and thus of the differential planetary gear 30, in each case a respective one of the gaps 56 is arranged between two directly adjacent teeth 50. The toothing 52 has second gaps 58, which are also referred to as second tooth gaps. In the circumferential direction, running around the planetary rotational axis 32, of the coupling planetary gear 44 and of the toothing 52, in each case one of the second gaps 58 is arranged between two directly adjacent teeth 54. The respective gap 56 is also referred to as a first tooth gap, and the respective gap 58 is also referred to as a second tooth gap. In the first embodiment of the differential staged planetary gear 46, shown in FIG. 4, the toothings 48 and 52 are oriented rotationally from each other, as viewed around the planetary rotational axis 32, in such a way that the respective first gaps 56 align with the respective second gaps 58 in the axial direction of the differential staged planetary gear 46 and thus with each other as viewed along the first planetary rotational axis 32.

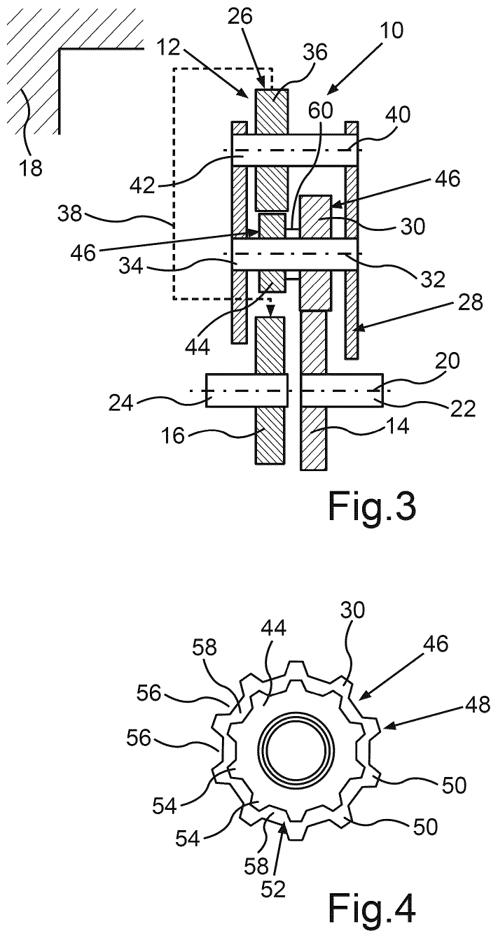

In the first embodiment of the transmission device 10, shown in FIGS. 1 and 2, the first differential planetary gear 30 and the coupling planetary gear 44 are designed separately from each other and are connected to each other. The first differential planetary gear 30 and the coupling planetary gear 44 border, in particular abut, each other directly, as viewed in the axial direction of the differential staged planetary gear 46 and thus along the first planetary rotational axis 32, so that, for example, the first differential planetary gear 30 and the coupling planetary gear 44 come directly into contact with each other in the axial direction of the differential staged planetary gear 46. FIG. 3 shows a second embodiment of the transmission device 10, in a schematic and sectional side view. For example, the first differential planetary gear 30 and the associated coupling planetary gear 44 are also designed separately from each other and are connected, in particular permanently, to each other for conjoint rotation in the second embodiment. In comparison to the first embodiment, however, an intermediate region 60 is arranged between the first differential planetary gear 30 and the associated coupling planetary gear 44, as viewed in the axial direction of the differential staged planetary gear 46 and thus along the first planetary rotational axis 32, and the intermediate region can be referred to as a transition region or designed as a transition region. For example, the first differential planetary gear 30, in particular the toothing 48 thereof, has a first width, running in the axial direction of the differential staged planetary gear 46, by which, for example, the toothing 48 engages into the sun gear 14. For example, the coupling planetary gear 44, in particular the toothing 52 thereof, has a second width, in particular second toothing width, running in the axial direction of the differential staged planetary gear 46, by which, for example, the toothing 52 engages into the differential planetary gear 36. For example, the first width is also labelled with b1, and the second width is also labelled with b2. It is also conceivable that the intermediate region 60 has a third width, also labelled with b3 and running in the axial direction of the differential staged planetary gear 46.

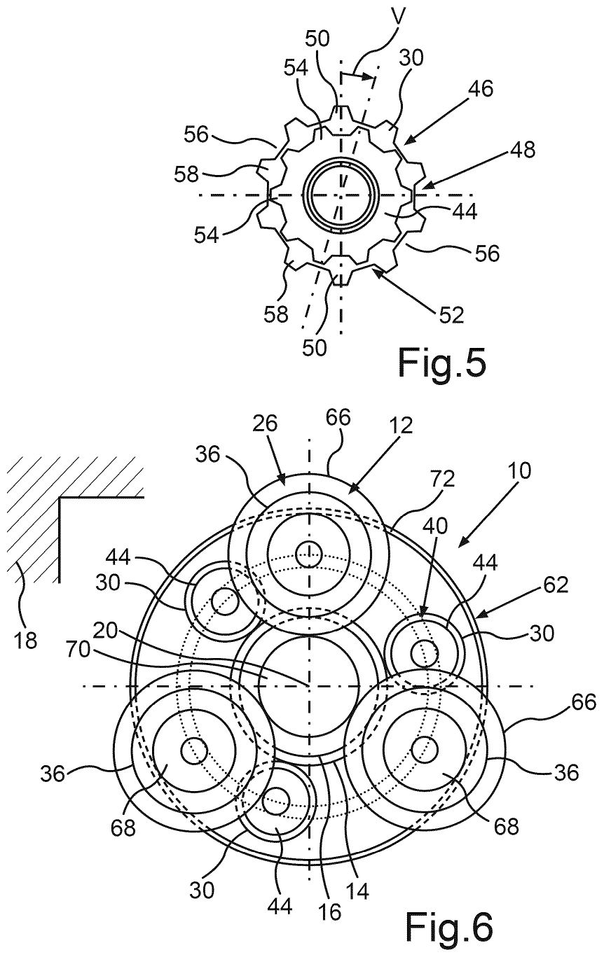

FIG. 5 shows a second embodiment of the differential staged planetary gear 46, in a schematic front view. In the second embodiment, the toothings 48 and 52 are oriented rotationally to each other, as viewed in the circumferential direction of the differential staged planetary gear 46, running around the first planetary rotational axis 32, in such a way that the first gaps 56 of the first toothing 48 of the first differential planetary gear 30 align with the second teeth 54 of the second toothing 52 of the coupling planetary gear 44, as viewed in the axial direction of the differential staged planetary gear 46, and that the first teeth 50 of the first toothing 48 of the first differential planetary gear 30 align with the second gaps 58 of the second toothing 52 of the coupling planetary gear 44, as viewed in the axial direction of the differential staged planetary gear 46. Alternatively, it is conceivable that, while in the first embodiment of the differential staged planetary gear 46 shown in FIG. 4 the toothings 48 and 52 are exactly aligned in the axial direction of the differential staged planetary gear 46, and thus the teeth 50 are exactly aligned with the teeth 54 and the gaps 56 are exactly aligned with the gaps 58 in the axial direction of the differential staged planetary gear 46, in the second embodiment of the differential staged planetary gear 46 shown in FIG. 5, the teeth 48 and 52 are not aligned, but are offset or twisted relative to each other by an offset angle V in the circumferential direction of the differential staged planetary gear 46 running around the first planetary rotational axis 32, so that, for example, at least respective partial regions of the teeth 50 and the gaps 58 and at least respective partial regions of the gaps 56 and the teeth 54 are arranged at the same height or in the same rotational position as viewed around the circumferential direction of the differential staged planetary gear 46.

Preferably, in the second embodiment of the transmission device 10, shown in FIG. 3, it is provided that the third width b3 of the intermediate region 60 is smaller than the first width b1 of the first staged planet and smaller than the second width b2 of the staged planet. It is conceivable that the first width and the second width are identical, or the first width and the second width can differ from each other.

Preferably, it is provided that the first sun gear 14 has a third toothing, having a third tooth count and a third toothing module, which third toothing engages into the first differential planetary gear 30, in particular into its first toothing 48, and has third teeth with a respective, third tooth height. The second sun gear 16, for example, has a fourth toothing, having a fourth tooth count and a fourth toothing module, which fourth toothing engages into the second differential planetary gear 36, in particular into its fifth toothing, and has fourth teeth with a respective, fourth tooth height. In this case, it is preferably provided that the third tooth count and the fourth tooth count differ from each other, wherein preferably the third toothing module and the fourth toothing module are identical, so that preferably the respective third tooth height and the respective fourth tooth height are identical. Therefore, it is preferably provided that all toothings of the spur gear differential 12 have straight-sided splines.

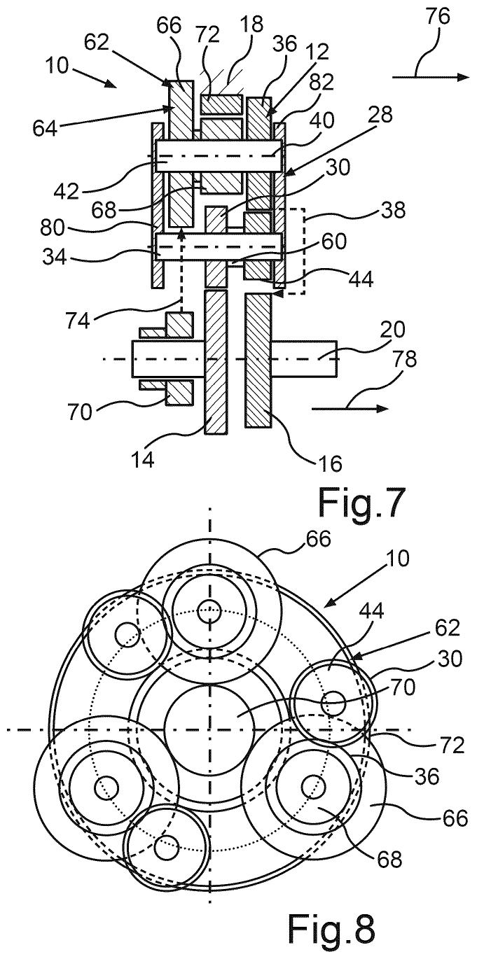

FIGS. 6 and 7 show a third embodiment of the transmission device 10, in a schematic front view and in a schematic and sectional side view, respectively. In the third embodiment, the transmission device 10 has a planetary transmission 62, provided in addition to the spur gear differential 12, which is explained in more detail in the following. The planetary transmission 62 has at least one staged planetary gear 64, provided in addition to the differential staged planetary gear 46 or in addition to the differential staged planetary gears 46, which is held on the planetary carrier 28 so as to be rotatable around the second planetary rotational axis 40 relative to the planetary carrier 28. In the third embodiment, the staged planetary gear 64 is arranged, in particular mounted, on the second bolt 42 so as to be rotatable around the planetary rotational axis 40 relative to the bolt 42 and relative to the planetary carrier 28. Thus, in the third embodiment, the staged planetary gear 64 is arranged coaxially to the second differential planetary gear 36. In particular, the second differential planetary gear 36 and the staged planetary gear 64 can be rotated around the second planetary rotational axis 40 relative to each other. For example, the planetary transmission 62 can have at least one further or several further staged planetary gears, wherein the preceding and following embodiments for the staged planetary gear 64 can be easily transferred to the respective, further staged planetary gear and vice versa. In particular, each second differential planetary gear 36 is provided with a respective staged planetary gear 64.

The staged planetary gear 64 has a first planetary gear 66 and a second planetary gear 68, wherein the planetary gears 66 and 68 are connected, in particular permanently, to each other for conjoint rotation. The planetary gears 66 and 68 are spur gears. This means the planetary gears 66 and 68 are gear wheels, which are designed as spur gears. Preferably, the planetary gears 66 and 68 are also straight-splined. The planetary gear 66 is also referred to as a third staged planet, and the planetary gear 68 is also referred to as a fourth staged planet. It can be seen that the planetary gears 66 and 68 are different sizes, i.e., have different rolling circle diameters and/or different pitch circle diameters, in the present case in such a way that the planetary gear 66 has a fifth rolling circle diameter and the planetary gear 68 is a sixth rolling circle diameter, which is smaller than the fifth rolling circle diameter. Therefore, the planetary gear 66 is also referred to as a large planetary gear or larger planetary gear, and the planetary gear 68 is also referred to as a small planetary gear or smaller planetary gear.

The planetary transmission 62 furthermore has a third sun gear 70, provided in addition to the first sun gear 14 and in addition to the second sun gear 16, which third sun gear is also referred to as a drive sun gear or drive sun. Preferably, the third sun gear 70 is also a spur gear and preferably straight-splined. It can be seen that the large planetary gear, i.e., in the present case the planetary gear 66, engages into the third sun gear 70. In other words, the large planetary gear is engaged with the third sun gear 70. The planetary transmission 62 furthermore has a ring gear 72 which in the third embodiment is connected, in particular permanently, to the housing 18 for conjoint rotation. In an alternative embodiment, it would be conceivable that a switching element is provided which can be switched between a coupled state and a decoupled state. In the coupled state, for example, the ring gear 72 is connected to the housing 18 by means of the switching element for conjoint rotation. In the decoupled state, the switching element, for example, releases the ring gear 72 for rotations occurring around the rotational axis (sun gear rotational axis 20) relative to the housing 18, so that the ring gear 72 can rotate in the decoupled state around the rotational axis relative to the housing 18. In the third embodiment, the planetary transmission 62 is thus arranged coaxially to the spur gear differential 12. In this case, the sun gear 70 is arranged coaxially to the sun gears 14 and 16 and thus can be rotated around the sun gear rotational axis 20 relative to the housing 18. Furthermore, it can be seen that the planetary carrier 28 is a planetary carrier common to the spur gear differential 12 and to the planetary transmission 62, on which planetary carrier the staged planetary gear 64 is also held so as to be rotatable around the second planetary rotational axis 40. It can be seen that the small planetary gear, i.e., in the present case planetary gear 68, is engaged with the ring gear 72.

For example, the sun gear 70 can be driven by the drive motor, so that the aforementioned drive torque can be provided, for example, via the planetary transmission 62 and can be introduced into the spur gear differential 12 via the planetary transmission 62, in order to thereby drive the planetary carrier 28 and thus the spur gear differential 12. Thus, preferably the planetary carrier 28 is designed as a drive of the spur gear differential 12, via the drive of which the aforementioned drive torque of the spur gear differential 12 can be introduced.

In FIG. 3, a dashed arrow 74 means “meshes with”, such that it is illustrated by the dashed arrow 74 that the sun gear 70 meshes with the large planetary gear (planetary gear 66), i.e., is engaged with the large planetary gear.

In order to be able to realize a particularly compact design, in particular as viewed in the axial direction of the transmission device 10 and thus along the sun gear rotational axis 20, it is provided in the third embodiment that the second differential planetary gear 36 adjoins the ring gear 72 and adjoins the planetary gear 68, which is engaged with the ring gear 72, in a direction running in the axial direction of the second differential planetary gear 36 and thus running parallel to the second planetary rotational axis 40 or coinciding with the second planetary rotational axis 40, illustrated in FIG. 7 by an arrow 76, wherein the ring gear 72 and the planetary gear 68 engaged therewith adjoin the planetary gear 66 in the direction illustrated by the arrow 76, whereby the ring gear 72 and the planetary gear 68 are arranged between the second differential planetary gear 36 and the planetary gear 66, as viewed in the axial direction of the second differential planetary gear 36 and presently also in the axial direction of the staged planetary gear 64 and thus along the second planetary rotational axis 40.

In the third embodiment of the transmission device 10, the first rolling circle diameter of the first sun gear 14 is larger than the second rolling circle diameter of the second sun gear 16, as in the first embodiment and the second embodiment of the transmission device 10. In the second embodiment, the second sun gear 16 adjoins the second sun gear 14, in an arrangement direction, illustrated by an arrow 78 in FIG. 3, running in the axial direction of the sun gears 14 and 16 and thus running parallel to the sun gear rotational axis 20, or coinciding with the sun gear rotational axis 20, wherein in the present case, the arrangement direction illustrated by the arrow 78 corresponds to the direction illustrated by the arrow 76. The first sun gear 14 adjoins the third sun gear 70 in the arrangement direction (arrow 78), whereby the first sun gear 14 is arranged between the second sun gear 16 and the third sun gear 70, as viewed in the axial direction of the sun gears 14, 16 and 70 and thus along the sun gear rotational axis 20.

Furthermore, it is provided that planetary carrier walls 80 and 82 of the planetary carrier 28, on the planetary carrier walls 80 and 82 of which the bolts 34 and 42 are fixed, in particular for conjoint rotation, are located exclusively on the outside, as viewed in the axial direction of the planetary transmission 62 and of the spur gear differential 12 and thus along the sun gear rotational axis 20, i.e., on both sides adjoin the ring gear 72, the staged planetary gear 64, the second differential planetary gear 36, the differential staged planetary gear 46 and the sun gears 14, 16 and 70 and thus are arranged outside both the planetary transmission 62 as well as the spur gear differential 12.

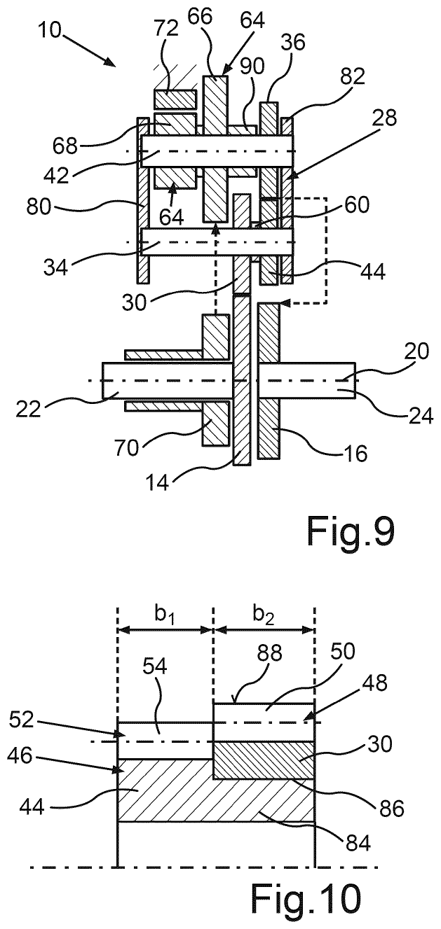

FIGS. 8 and 9 show a fourth embodiment of the transmission device 10, in a schematic front view and in a schematic and sectional side view, respectively. As in the third embodiment, the small planetary gear (planetary gear 68) engages into the ring gear 72, and the large planetary gear (planetary gear 66) engages into the third sun gear 70. In the fourth embodiment, however, it is provided that the large planetary gear (planetary gear 66) is arranged between the second differential planetary gear 36 and the small planetary gear (planetary gear 68) as viewed in the axial direction of the second differential planetary gear 36 and of the staged planetary gear 64, so that the planetary gear 66 is arranged between the second differential planetary gear 36 and the ring gear 72 as viewed in the axial direction of the staged planetary gear 64 and the second differential planetary gear 36.

FIG. 3 shows a third embodiment of the differential staged planetary gear 46. In the third embodiment, the differential planetary gear 30 and the associated coupling planetary gear 44 are also designed separately from each other and are connected to each other for conjoint rotation. The coupling planetary gear 44 has a projection 84, which in the present case is formed as a collar of the coupling planetary gear 44 or by a collar of the coupling planetary gear 44. The differential planetary gear 30 is arranged on the projection 84 and is connected, in particular permanently, to the projection 84 for conjoint rotation, whereby the differential planetary gear 30 is connected, in particular permanently, to the coupling planetary gear 44 for conjoint rotation. In the present case, the differential planetary gear 30 has a hub 36 in which the projection 84 is arranged. Thus, the differential planetary gear 30 is connected, in particular permanently, to the projection 84 and thus to the coupling planetary gear 44 via its hub 86 for conjoint rotation.

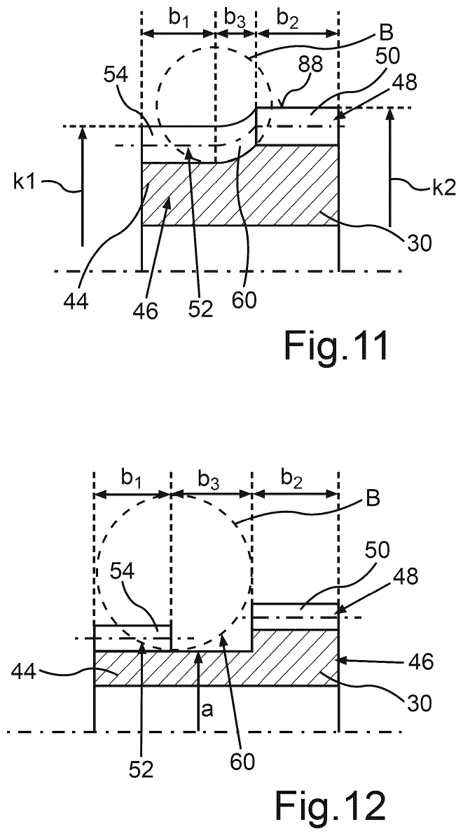

FIG. 11 shows a fourth embodiment of the differential staged planetary gear 46. In the fourth embodiment of the differential staged planetary gear 46, the first differential planetary gear 30 and the associated coupling planetary gear 44 are designed integrally with each other and are thereby connected, in particular permanently, to each other for conjoint rotation. In FIG. 11, a region is labelled B. As can be seen from FIG. 11, a radial outer contour 88 of the differential staged planetary gear 46 does not fall below a first tip circle diameter k1 of the second toothing 52 in the transition region (intermediate region 60), but increases from the first tip circle diameter k1 to a second tip circle diameter k2 of the first toothing 48, in particular at least substantially continually. In particular, for example, machining, in particular production, of the toothing 52 and/or the toothing 48 takes place in the region B, in particular by a toothing tool, so that the region B is a tool outlet region, for example.

FIG. 12 shows a fifth embodiment of the differential staged planetary gear 46. It can be seen from FIG. 12 that in the fifth embodiment, the intermediate region 60 (transition region) is free from a toothing.

It can be seen that the spur gear differential 12 comprises the planetary carrier 28, in particular which is drivable or driven in any way, and the two differently sized sun gears 14 and 16, which simultaneously represent the two driven gears of the spur gear differential 12, also referred to as outputs. Furthermore, the spur gear differential 12 comprises the differential staged planetary gear 46 or preferably a group of respectively identical differential staged planetary gears 46, wherein the group comprises in each case at least or more than two identical differential staged planetary gears 46. Preferably, the differential staged planetary gears 46 are arranged evenly distributed in the circumferential direction of the spur gear differential 12 running around the sun gear rotational axis 20, in particular over a respective circumference of the respective sun gear 14, 16. Furthermore, the spur gear differential 12 comprises the second differential planetary gear 36 or preferably a group of identical differential planetary gears 36, wherein preferably the several differential planetary gears 36 are arranged evenly distributed in the circumferential direction of the spur gear differential 12 running around the sun gear rotational axis 20. In particular, each differential staged planetary gear 46 is provided with a respective second differential planetary gear 36. The differential staged planetary gears 46 and the second differential planetary gears 36 are rotatably mounted at, in particular on, their respectively associated bolts 34 and 42. For this purpose, for example, rolling and/or plain bearings can be used. The bolts 34 and 42 are fixed on, in particular in the planetary carrier 28, in particular for conjoint rotation. The planetary carrier 28 can be designed in one part or several parts, i.e., as one piece or several pieces. The planetary carrier 28 is mounted directly or indirectly, in particular rotatably, with respect to the one-part or multi-part housing 18 which, for example, is designed as a transmission housing or as a drive housing. For example, direct mounting between the planetary carrier 28 and the housing takes place via at least or exactly two bearings designed, for example, as plain bearings or roller bearings, in particular such that the planetary carrier 28 is rotatably mounted on the housing 18 via the bearings, in particular such that the planetary carrier 28 is rotatable around the rotational axis relative to the housing 18. The second differential planetary gear 36 meshes with the second, smaller sun gear 16 and with the coupling planetary gear 44 that is smaller than the first differential planetary gear 30, in particular in each case directly, and preferably otherwise with no other, further gear wheel. The first differential planetary gear 30 meshes, for example, exclusively with the first, larger sun gear 14. To apply identical torques to the two sun gears 14 and 16, i.e., so that the drive torque can be or is distributed heavily and thus in equal parts to the sun gears 14 and 26 and thus to the side shafts 22, 24, the ratios are identical between the rolling circle diameters of the sun gears 14 and 16 and those of the staged planets (differential planetary gear 30 and coupling planetary gear 44) of the differential staged planetary gear 46, so that:

WS1/WS2=WSP1/WSP2

Here, WS1 refers to the first rolling circle diameter of the first sun gear 14, WS2 refers to the second rolling circle diameter of the second sun gear 16, WSP1 refers to the third rolling circle diameter of the first differential planetary gear 30 and WSP2 refers to the fourth rolling circle diameter of the coupling planetary gear 44. As described above, the first rolling circle diameter is larger than the second rolling circle diameter and the third rolling circle diameter is larger than the fourth rolling circle diameter.

Entire toothings of the spur gears can have straight-sided splines or be helically toothed. A straight spline is preferred. If, as shown in FIG. 4, the toothings 48 and 52 are oriented rotationally to each other in such a way that the teeth 50 align exactly with the teeth 54, so that gap 56 is exactly on gap 58 and tooth 50 is exactly on tooth 54, a tool outlet for a toothing tool for producing the smaller toothing 52 can therefore project to a certain extent into the gaps of the larger toothing 48, for example, without eroding material in the region of the larger toothing 48. A collar is labelled 90, by means of which a particularly wide mounting base of the staged planetary gear 64 can be represented.

In this manner, the unusable intermediate region 60 can be kept small or short between the toothings 48 and 50 in the axial direction of the differential staged planetary gear 46. The smaller the difference between the third rolling circle diameter and the fourth rolling circle diameter, the smaller or shorter the intermediate region 60 which is unusable for toothing will also advantageously be.

If the differential planetary gear 30 and the associated coupling planetary gear 44 are designed separately from each other and are connected to each other for conjoint rotation, then the connection between the differential planetary gear 30 and the associated coupling planetary gear 44 for conjoint rotation can be designed via a press fit, via a plug-in toothing, a welding seam, a combination of these connections or in another manner. An advantage in this case is that the differential planetary gear 30 and the associated coupling planetary gear 44 can be designed to be axially directly adjacent, i.e., without the intermediate region 60, whereby a particularly short axial construction can be achieved.

Preferably, however, the intermediate region 60 is provided with the width B3 between the differential planetary gear 30 and the coupling planetary gear 44, i.e., between the toothings 48 and 52. For example, a tool outlet of the toothing tool for producing the toothing 52 of the coupling planetary gear 44 is located in the intermediate region 60. The toothing tool, also simply referred to as a tool, for example, even enters the region of the toothing 48 of the differential planetary gear 30, however only into the gaps 56 of the toothing 48, so that the toothing 48 is not damaged, machined or otherwise impaired by the toothing tool, by means of which the toothing 52 is produced. In the intermediate region 60, the teeth 54 of the toothing 52 grow, as it were, from the second rolling circle diameter or from the tip circle diameter k1 to the first rolling circle diameter or to the tip circle diameter k2. The radial outer contour 88 of the differential staged planetary gear 46 therefore does not fall below the tip circle diameter k1 of the coupling planetary gear 44, which is smaller than the first differential planetary gear 30, in the intermediate region 60. Preferably, the difference between the first rolling circle diameter of the differential planetary gear 30 and the second rolling circle diameter of the coupling planetary gear 44 selected is as small as possible, as consequently the width b3 of the intermediate region 60 can be kept small. Advantages of this embodiment are in particular:
the differential staged planetary gear 46 can be designed as one part or integrally, whereby the costs can be kept particularly low;
by immersing the toothing tool for producing the toothing 52 into the toothing 48, the width b3, which represents a distance between the differential planetary gear 30 and the coupling planetary gear 44, running in the axial direction of the differential staged planetary gear 46, can be kept small; and
tooth root strength is higher than with stepped teeth.

Finally, as shown in FIG. 12, it is conceivable in the fifth embodiment that the intermediate region 60 with the width b3 exists between the two toothings 48 and 52 or between the differential planetary gear 30 and the associated coupling planetary gear 44 as viewed in the axial direction of the differential staged planetary gear 46, wherein in the fifth embodiment shown in FIG. 12, the outer diameter of the differential staged planetary gear 46 within the intermediate region 60 is significantly smaller than the tip circle diameter k1 of the teeth 54 or the toothing 52 that is smaller than the tip circle diameter k2 of the teeth 50 or the toothing 48. The outer diameter is labelled with a in FIG. 12. The outer diameter a can even the same size as or smaller than a root diameter of the toothing 52 in this intermediate region 60. It is conceivable that, for example, the toothing tool for producing the toothing 52 does not enter into the region or into the gaps 56 of the toothing 48. In precisely this case, it is advantageous not to axially align the teeth 50 and 54 of the toothings 48 and 52, but, as shown in FIG. 5, to twist the toothings 48 and 52 relative to each other around the planetary rotational axis 32. This rotational alignment or twisting of the toothings 48 and 52 can at least be freely selected, but should be the same for all differential staged planetary gears 46, so that an advantageous assembly of the spur gear differential 12 can be achieved. In this concrete embodiment case, the toothings 52 and 48 should therefore not necessarily have the same tooth count. As a disadvantage, this can result in a large width b3 between the toothings 48 and 52, however this can be classified as acceptable. The advantages resulting therefrom can be:
an integral or one-piece design; and
a simpler production process.

It is conceivable that the tooth count in the toothings 48 and 52 are identical, wherein, for example, as in the first embodiment shown in FIG. 4, it is provided that the teeth 50 and 54 of the two toothings 48 and 52 align in the axial direction of the differential staged planetary gear 46. Alternatively, it is conceivable that, as shown in FIG. 5, the toothings 48 and 52 are arranged twisted relative to each other as opposed to being aligned with each other, as viewed in the circumferential direction of the differential staged planetary gear 46.

In particular, the following advantages can be realized by the transmission device 10:
in classic bevel gear differentials, high axial expansion forces arise between the bevel gears during torque transmission, which must be absorbed by solid housings, often made of grey cast iron. In the case of the transmission device 10, advantageously, no significant axial forces are generated in the housing 18, wherein the installation space requirement in the axial direction can be kept particularly low, and the planetary carrier 28 can be designed to be significantly lighter than a grey cast iron housing of a bevel differential;
a disadvantage with conventional solutions may be that there must be a significant axial intermediate space between the two sun gears 14 and 26, in which the two wide planet gears mesh with each other without being in interlocking engagement with one of the two suns in this region. In contrast, the axial installation space requirement can be kept particularly low with the transmission device 10, and the weight and the material costs can be kept particularly low; and
the above-mentioned problem can, for example, be solved by using toothings with extreme profile shifts at least in part, which, however, can be a disadvantage for the structural durability and the specific load-bearing capacity of the profile-shifted gear wheels concerned and has to be compensated for via a significant widening of the profile-shifted toothings. Furthermore, the extreme profile shift has a disadvantageous effect on the rolling behaviour and thus on the noise emission of the profile-shifted toothings. These disadvantages and problems can be avoided with the transmission device 10. Thus, a lower axial installation space requirement, a lower weight and lower material costs can be realized. Furthermore, lower mechanical stimulation (noise emission) within the toothing can be achieved at a relative speed.

List of reference characters:

| | |
|---|---|
| 10 | transmission device |
| 12 | spur gear differential |
| 14 | first sun gear |
| 16 | second sun gear |
| 18 | housing |
| 20 | sun gear rotational axis |
| 22 | first side shaft |
| 24 | second side shaft |
| 26 | planetary gear set |
| 28 | planetary carrier |
| 30 | first differential planetary gear |
| 32 | first planetary rotational axis |
| 34 | bolt |
| 36 | second differential planetary gear |
| 38 | dashed arrow |
| 40 | second planetary rotational axis |
| 42 | bolt |
| 44 | coupling planetary gear |
| 46 | differential staged planetary gear |
| 48 | first toothing |
| 50 | first tooth |
| 52 | second toothing |
| 54 | second tooth |
| 56 | first gap |
| 58 | second gap |
| 60 | intermediate region |
| 62 | planetary transmission |
| 64 | staged planetary gear |
| 66 | first planetary gear |
| 68 | second planetary gear |
| 70 | third sun gear |
| 72 | ring gear |
| 74 | dashed arrow |
| 76 | arrow |
| 78 | arrow |
| 80 | planetary carrier wall |
| 82 | planetary carrier wall |
| 84 | projection |
| 86 | hub |
| 88 | outer contour |
| 90 | collar |
| b1 | first width |
| b2 | second width |
| b3 | third width |
| B | region |
| V | offset angle |
| a | outer diameter |
| k1 | first tip circle diameter |
| k2 | second tip circle diameter |

1.-14. (canceled)

15. A transmission device (10) for a motor vehicle, comprising:
a spur gear differential (12) which has:
a first sun gear (14) which is designed as a first driven gear of the spur gear differential (12) and as a first spur gear and has a first rolling circle diameter;
a second sun gear (16) which is arranged coaxially to the first sun gear (14) and which is designed as a second driven gear of the spur gear differential (12) and as a second spur gear and has a second rolling circle diameter that is different from the first rolling circle diameter; and
a planetary gear set (26) via which the first and second sun gears (14, 16) are coupled to each other such that the first and second sun gears (14, 16) are rotatable in opposite directions;
wherein the planetary gear set (26) has:
a planetary carrier (28);
a first differential planetary gear (30) which engages into the first sun gear (14), has a third rolling circle diameter and is held on the planetary carrier (28) so as to be rotatable around a first planetary rotational axis (32) relative to the planetary carrier (28);
a second differential planetary gear (36) which engages into the second sun gear (16), is held on the planetary carrier (28) so as to be rotatable relative to the planetary carrier (28) around a second planetary rotational axis (40) running parallel to the first planetary rotational axis (32) and spaced apart from the first planetary rotational axis (32); and
a coupling planetary gear (44) which is arranged coaxially to the first differential planetary gear (30), is connected to the first differential planetary gear (30) for conjoint rotation and engaging into the second differential planetary gear (36) and thereby coupling the first and second differential planetary gears (30, 36) to each other, the coupling planetary gear (44) having a fourth rolling circle diameter, differing from the third rolling circle diameter, and forming a differential staged planetary gear (46) with the first differential planetary gear (30), which is held on the planetary carrier (28) so as to be rotatable around the first planetary rotational axis (32) relative to the planetary carrier (28) and has the first differential planetary gear (30) as a first staged planet and the coupling planetary gear (44) as a second staged planet;
wherein a first ratio between the first rolling circle diameter and the second rolling circle diameter and a second ratio between the third rolling circle diameter and the fourth rolling circle diameter are identical.

16. Transmission device (10) according to claim 15, wherein:
the first differential planetary gear (30) has a first toothing (48) having a first tooth count and a first toothing module, wherein the first toothing (48) engages into the first sun gear (14) and has first teeth (50) with a respective first tooth height; and
the coupling planetary gear (44) has a second toothing (52) having a second tooth count and a second toothing module, wherein the second toothing (52) engages into the second differential planetary gear (36) and has second teeth (54) with a respective second tooth height.

17. Transmission device (10) according to claim 16, wherein:
the first tooth count and the second tooth count are identical;
the first toothing module and the second toothing module differ from each other; and
the respective first tooth height and the respective second tooth height differ from each other.

18. Transmission device (10) according to claim 16, wherein the first toothing (48) and the second toothing (52) are oriented rotationally to each other such that a respective gap (56) of the first toothing (48) of the first differential planetary gear (30) aligns with a respective gap (58) of the second toothing (52) of the coupling planetary gear (44).

19. The transmission device (10) according to claim 15, wherein the first and second staged planets are integral with each other.

20. The transmission device (10) according to claim 19, wherein:
the first differential planetary gear (30) has a first toothing (48) having a first tooth count and a first toothing module, wherein the first toothing (48) engages into the first sun gear (14) and has first teeth (50) with a respective first tooth height; and
the coupling planetary gear (44) has a second toothing (52) having a second tooth count and a second toothing module, wherein the second toothing (52) engages into the second differential planetary gear (36) and has second teeth (54) with a respective second tooth height.
a transition region (60) with a third width (b3) is provided between the first staged planet with a first width (b1) and the second staged planet with a second width (b2) in an axial direction, wherein a radial outer contour (88) of the differential staged planetary gear (46) does not fall below a first tip circle diameter (k1) of the second toothing (52) in the transition region (60), but increases from the first tip circle diameter (k1) to a second tip circle diameter (k2) of the first toothing (48).

21. The transmission device (10) according to claim 20, wherein the third width (b3) of the transition region (60) is smaller than the first width (b1) of the first staged planet and smaller than the second width (b2) of the second staged planet.

22. The transmission device (10) according to claim 15, wherein the first differential planetary gear (30) and the coupling planetary gear (44) are designed separately from each other and are connected to each other, wherein the coupling planetary gear (44) has a projection (84), and wherein the first differential planetary gear (30) is connected to the projection (84).

23. The transmission device (10) according to claim 22, wherein the first and second staged planets directly border each other in an axial direction.

24. The transmission device (10) according to claim 15, wherein:
the first differential planetary gear (30) has a first toothing (48) having a first tooth count and a first toothing module, wherein the first toothing (48) engages into the first sun gear (14) and has first teeth (50) with a respective first tooth height; and
the coupling planetary gear (44) has a second toothing (52) having a second tooth count and a second toothing module, wherein the second toothing (52) engages into the second differential planetary gear (36) and has second teeth (54) with a respective second tooth height.
the first sun gear (14) has a third toothing having a third tooth count and a third toothing module, wherein the third toothing engages into the first differential planetary gear (30) and has third teeth with a respective third tooth height;
the second sun gear (16) has a fourth toothing having a fourth tooth count and a fourth toothing module, wherein the fourth toothing engages into the second differential planetary gear (36) and has fourth teeth with a respective fourth tooth height;
the third tooth count and the fourth tooth count differ from each other;
the third toothing module and the fourth toothing module are identical; and
the respective third tooth height and the respective fourth tooth height are identical.

25. The transmission device (10) according to claim 15, wherein all toothings of the spur gear differential (12) have straight-sided splines.

26. The transmission device (10) according to claim 15, further comprising:
a planetary transmission (62) which has:
a staged planetary gear (64) provided in addition to the differential staged planetary gear (46) and held rotatably on the planetary carrier (28), wherein the staged planetary gear (64) has a first planetary gear (66) as a third staged planet and a second planetary gear (68) as a fourth staged planet connected to the third staged planet for conjoint rotation;
a third sun gear (70) as a drive sun gear provided in addition to the first sun gear (14) and in addition to the second sun gear (16), wherein one of the first and second planetary gears (66, 68) is engaged with the third sun gear (70); and
a ring gear (72) that is connected to a housing (18) of the transmission device (10) for conjoint rotation, wherein the other one of the first and second planetary gears (68, 66) is engaged with the ring gear (72).

27. The transmission device (10) according to claim 26, wherein in a direction (76) running in an axial direction of the second differential planetary gear (36), the second differential planetary gear (36) adjoins the ring gear (72), adjoins the first planetary gear (66) and adjoins the second planetary gear (68) of the planetary transmission (62), wherein the ring gear (72) and the second planetary gear (68) adjoin the first planetary gear (66) in the direction (76), and wherein the ring gear (72) and the second planetary gear (68) are arranged between the second differential planetary gear (36) of the spur gear differential (12) and the first planetary gear (66) of the planetary transmission (62), as viewed in the axial direction of the second differential planetary gear (36).

28. The transmission device (10) according to claim 26, wherein the first rolling circle diameter of the first sun gear (14) is larger than the second rolling circle diameter of the second sun gear (16) which adjoins the first sun gear (14) in an arrangement direction (78) running in an axial direction of the first sun gear (14) and the second sun gear (16), wherein the first sun gear (14) adjoins the third sun gear (70) in the arrangement direction (78), and wherein the first sun gear (14) is arranged between the second sun gear (16) and the third sun gear (70), as viewed in the axial direction of the first sun gear (14) and the second sun gear (16).
